(19) United States
(12) Patent Application Publication
(10) Pub. No.: US 2026/0037504 A1
(43) Pub. Date: Feb. 5, 2026

(54) PRIORITIZING CONTENT ITEMS WITH DATA FIELDS MISSING FROM SEARCH QUERIES

(71) Applicant: Ancestry.com Operations Inc., Lehi, UT (US)

(72) Inventor: Gann Bierner, Oakland, CA (US)

(21) Appl. No.: 19/277,750

(22) Filed: Jul. 23, 2025

Related U.S. Application Data
(60) Provisional application No. 63/679,504, filed on Aug. 5, 2024.

(51) Int. Cl. G06F 16/245

(52) U.S. Cl. CPC G06F 16/245

(57) ABSTRACT

The present disclosure is directed toward systems, methods, and non-transitory computer-readable media for utilizing an improved search algorithm which prioritizes content items that include data fields (or other information) missing from a search query. For example, in response to a search query, the disclosed systems can prioritize or rank candidate content items to focus on candidate content items which include new information. Indeed, the disclosed systems can prioritize content items that include new information by ranking according to which content items include data fields missing from the search query. In some cases, the disclosed systems can prioritize content items with new information by determining which content items include data fields not already stored within a database associated with a user account (e.g., the user account performing the search) and/or for a particular entity or record within a genealogical database.

### CROSS-REFERENCE TO RELATED PATENT APPLICATIONS

This application claims priority to and the benefit of U.S. Provisional Patent Application No. 63/679,504, filed on Aug. 5, 2024, which is incorporated herein by reference in its entirety.

### BACKGROUND

Advancements in computing devices and networking technology have given rise to a variety of innovations in cloud-based genealogical data storage, sharing, and generation. For example, online historical content systems can provide access to digital genealogical content items across devices all over the world. To facilitate such access, modern historical content systems can provide search functions for sifting through large quantities of genealogical data to identify relevant genealogical content items, including birth certificates, digitized newspaper articles, images, census records, obituaries, court documents, military records, immigration records, and other types of digitized historical documents relevant to the search query. Despite these advances, however, existing historical content systems continue to suffer from a number of disadvantages, particularly in terms of robustness and database expansion.

As just suggested, certain existing historical content systems produce search results that are shallow or uninformative. More particularly, when identifying relevant genealogical content items to surface to client devices for search results, many existing systems apply algorithms that consider only certain factors. For example, in response to a search query for genealogical content items pertaining to a deceased relative, the shallow algorithms of some existing systems surface results that include data which best matches fields of the search query without considering how the search results impact database expansion. Consequently, the search functions of some existing systems generate repetitive results which, in some cases, include content items that include the same information as one another, resulting in little to no new information for incorporating into genealogy trees or other databases.

In addition, in part due to generating repetitive results, existing historical content systems are inefficient. Specifically, because users are often performing searches to identify new information to add to genealogical databases and genealogy trees, existing systems require repeated or serial searches to identify additional information. For instance, users will submit multiple queries, including additional details or slightly changing details in an effort for the existing systems to retrieve additional information to add to a genealogy tree and/or genealogical database. Since each individual search requires CPU cycles, memory access, and often disk I/O, repetitive searches cause a redundant workload on these computing systems, leading to redundant processing where the same data may be loaded, scanned, or filtered multiple times. Further, because existing historical content systems often search for content items specific to a user, existing systems repeatedly traverse the same data, performing may partial or overlapping passing, unnecessarily wasting bandwidth.

Further, existing historical content systems require excessive user interactions to add data to data fields of a content item. Specifically, existing systems require multiple navigations across multiple interfaces to add a single fact. For instance, adding a data fact (e.g., a marriage date) includes searching for a data fact, then either accessing the person's profile, navigating to the right event type (e.g., marriage date data field), selecting the data from the search result, then confirming with additional user interactions to save and/or attach the data to a content item.

### SUMMARY

This disclosure describes one or more embodiments of systems, methods, and non-transitory computer-readable storage media that provide benefits and/or solve one or more of the foregoing and other problems in the art. In particular, the disclosed systems provide an improved search algorithm which prioritizes content items that include data fields (or other information) missing from a search query. For example, the disclosed systems can generate a number of candidate content items that correspond to terms or fields of a search query and can prioritize or rank the candidate content items to focus on candidate content items which include new (e.g., unknown or not already stored) information. Indeed, the disclosed systems can prioritize content items that include new information by ranking content items within a search result according to which content items include data fields missing from (or not found in) data fields indicated by the search query. In some cases, the disclosed systems can prioritize content items with new information by also (or alternatively) determining which content items include data fields not already stored within a database associated with a particular user account (e.g., the user account performing the search) and/or for a particular entity or record within a genealogical database.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a missing-field system can operate in accordance with one or more embodiments.

FIG. 2 illustrates an example diagram of an overview of a missing-field system identifying and prioritizing content items according to missing data fields in accordance with one or more embodiments.

FIG. 3 illustrates an example diagram of comparing data fields of content items with data fields of a search query in accordance with one or more embodiments.

FIGS. 4A-4B illustrate schematic diagrams of a missing-field system utilizing models to prioritize or identify content items for a search query in accordance with one or more embodiments.

FIG. 5 illustrates an example diagram for comparing data fields of content items with stored data in accordance with one or more embodiments.

FIGS. 6A-6D illustrate example graphical user interfaces of a missing-field system prioritizing and displaying content items with missing fields in accordance with one or more embodiments.

FIG. 7 illustrates a tree database and a cluster database of a missing-field system in accordance with one or more embodiments.

FIG. 8 illustrates a flowchart of a series of acts for prioritizing content items from a search query that include data fields missing from a search query in accordance with one or more embodiments.

FIG. 9 illustrates a block diagram of an example computing device for implementing one or more embodiments of the present disclosure.

FIG. 10 illustrates an exemplary computing environment in accordance with one or more embodiments.

### DETAILED DESCRIPTION

This disclosure describes one or more embodiments of a missing-field system that can generate search results for a search query using a missing-fields algorithm that prioritizes or ranks content items for search results according to which content items include missing fields (e.g., data fields not found in the search query). In certain use cases, user accounts interact with client devices to search genealogical databases for genealogical content items (e.g., birth certificates, digitized newspaper articles, images, census records, obituaries, court documents, military records, immigration records, and other types of digitized historical documents) to identify family members to link within genealogical trees stored within one or more genealogical tree databases and/or to add genealogical content items to existing nodes within genealogical trees. As part of this process, the missing-field system can identify content items that include new data or new information, such as data fields missing from parameters of a search query and/or data fields not found in a database for a user account performing a search (e.g., a genealogy tree database for the user account).

To identify and provide content items that include new information, the missing-field system can compare data fields of content items with data fields of a search query. To elaborate, the missing-field system can receive a search query from a client device, where the search query defines data fields to use as the basis for generating search results. Indeed, the missing-field system can search or analyze a database that stores a repository of (genealogical) content items to identify candidate content items for the search query. For instance, the missing-field system identifies candidate content items that correspond to one or more data fields defined by the search query. Specifically, the missing-field system can determine candidate content items that include data fields that match (or are within a threshold similarity of) data fields defined by a search query.

In some embodiments, to prioritize content items, the missing-field system compares data fields amongst candidate content items. More specifically, from among a set of candidate content items for a search query, the missing-field system compares respective data fields of the candidate content items to identify content items that include data not found in other content items. For example, the missing-field system identifies entire data fields missing from some content items and/or identifies data fields in some content items that include more information (e.g., that are filled more completely) than those of other content items. In some cases, the missing-field system generates search results that prioritize content items which include more information (e.g., more data fields and/or more complete data fields).

In one or more embodiments, to prioritize content items, the missing-field system compares data fields of candidate content items with stored data. In particular, the missing-field system can determine an entity (e.g., an individual, a group, or an organization) associated with a search query. The missing-field system can further determine stored data or stored information for the entity within a database associated with a user account performing the search, such as a genealogy tree database or some other database. Additionally, as part of the prioritization process, the missing-field system can use the entity-specific stored data as a basis for comparing with candidate content items corresponding to the search query. For instance, the missing-field system can compare data fields of candidate content items with stored data for a particular entity of a search query to identify candidate content items that include data fields not yet stored for the entity within a user account database (e.g., within the user account's genealogy tree).

To identify candidate content items and generate search results, in certain embodiments, the missing-field system utilizes one or more search models, such as statistical models or machine-learning models. For example, the missing-field system utilizes a statistical model that weights data fields of content items to indicate which content items are weighted more heavily (e.g., based on included more, or certain types of, data fields). In some cases, the missing-field system utilizes a machine-learning model that incorporates a search intent of a user account. Indeed, the missing-field system can predict a search intent for a user account based on prior searches and can thus identify candidate content items that correspond to the predicted search intent for a search query (and that include one or more data fields missing from the search query and/or from a user account database). Accordingly, the missing-field system can not only generate search results that include new information but can also do so in a personalized fashion, customized on a per-account, per-search basis.

As suggested above, the missing-field system can provide improvements or advantages over existing historical content systems. For example, the missing-field system can improve database comprehensiveness and robustness compared to prior systems. In particular, by prioritizing (genealogical) content items with additional/new data, such as fields missing from search queries, the missing-field system can expand databases for better completeness. Indeed, the missing-field system can surface new data that prior systems may not locate at all or may not locate as quickly. As a result, the missing-field system can fill out genealogy trees and other database structures with data that was previously missing, while other systems rely on extensive user interaction and data interpretation to navigate through search results to locate new information. Consequently, the missing-field system can further facilitate or produce more reliable (e.g., more comprehensive) genealogical databases.

Further, the missing-field system improves efficiency relative to existing historical systems by prioritizing results that include data fields missing from a search query and/or a stored content item. Specifically, because the missing-field system provides search results that prioritize data that is not redundant to the user, the missing-field system reduces the need for repeated searches, reducing overall requirements for bandwidth and processing resources. Further, the missing-field system generates field vectors for content items that can quickly identify data fields that are included and/or missing from a content item (or a stored content item). By using a field vector, the missing-field system can reduce the processing requirements and time necessary to generate search requirements.

Moreover, the missing-field system also reduces the number of interface interactions required to add additional details to a data field of existing content item. More particularly, the missing-field system can provide options to add data to an existing content item. For example, the missing-field system can provide an option to add data fields of missing data to content items within a search interface (or tree interface). Further, because the missing-field system prioritizes content items that include missing data, the missing-field system reduces interface interactions for adding missing data to a content item.

As illustrated by the foregoing discussion, the present disclosure utilizes a variety of terms to describe features and benefits of the missing-field system. Additional detail is hereafter provided regarding the meaning of these terms as used in this disclosure. As used herein, the term “content item” refers to a digital object or a digital file that includes information (e.g., genealogical information) interpretable by a computing device (e.g., a client device) to present information to a user. A content item can include a file such as a digital text file, a digital image file, a digital audio file, a webpage, a website, a digital video file, a web file, a link, a digital document file, or some other type of file or digital object. A content item can have a particular file type or file format, which may differ for different types of digital content items (e.g., digital documents, digital images, digital videos, or digital audio files). In some cases, a content item can refer to a genealogical content item that includes or depicts historical or genealogical information, such as a birth certificate, a digitized newspaper article, a digitized photograph of a relative, a digitized census record, a digitized obituary, a digitized court document, a digitized DNA analysis, or a digitized family tree. In some embodiments, a genealogical content item includes a content item selected or identified to surface to a client device, such as an item in a search result, a record hint (e.g., a stored genealogical content item), a digital story (e.g., a stored collection of genealogical content items arranged for a particular person, topic, or entity of a genealogical-data system), a digital image (e.g., a digitized photograph), a new person hint (e.g., a node to add to a genealogical tree), a member tree hint (e.g., a prediction for correcting a node within a genealogical tree of a user account), or a DNA match (e.g., a record indicating a DNA match of a user account to a relative whose information is stored in a genealogical-data system).

In some embodiments, a genealogical content item can take the form of a candidate content item or a candidate record. As used herein, the term “candidate content item” refers to a genealogical content item analyzed and compared with a search query to determine whether it matches or satisfies the search query. For example, a candidate content item includes a genealogical content item including one or more genealogical parameters or data fields that match or align with data fields of a search query, such as a first name, a last name, a location, and/or years associated with one or more life events (e.g., birth, death, marriage, medical operations, military enlistment, childbirth, immigration, tax payment, census information taken, etc.).

Additionally, as used herein, the term “field-weighting model” refers to a statistical model that analyzes a repository of (genealogical) content items to identify content items corresponding to a search query by applying weights to data fields. For example, a field-weighting model can include a heuristic model that applies weights to data fields such that content items with more data fields are weighted more heavily than (and therefore prioritized over) content items with fewer data fields. In some cases, a field-weighting model applies different weights to different types of data fields (e.g., last name vs. date of birth) and/or for different types of content items (e.g., birth certificates vs. military records).

In addition, as used herein, the term “machine-learning model” refers to a computer algorithm or a collection of computer algorithms that automatically improve for a particular task through iterative outputs or predictions based on use of data. For example, a machine-learning model can utilize one or more learning techniques to improve in accuracy and/or effectiveness. Example machine-learning models include various types of neural networks, decision trees, support vector machines, linear regression models, and Bayesian networks. In some embodiments, the missing-field system utilizes a large language machine-learning model in the form of a neural network.

Relatedly, as used herein, the term “neural network” refers to a machine-learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., search intent and/or content items) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network. Upon training as described below, such a neural network may become a “result prediction neural network” (or “result prediction machine-learning model”) that generates predicted content items as search results based on search data fields, search intent, and/or prior search data.

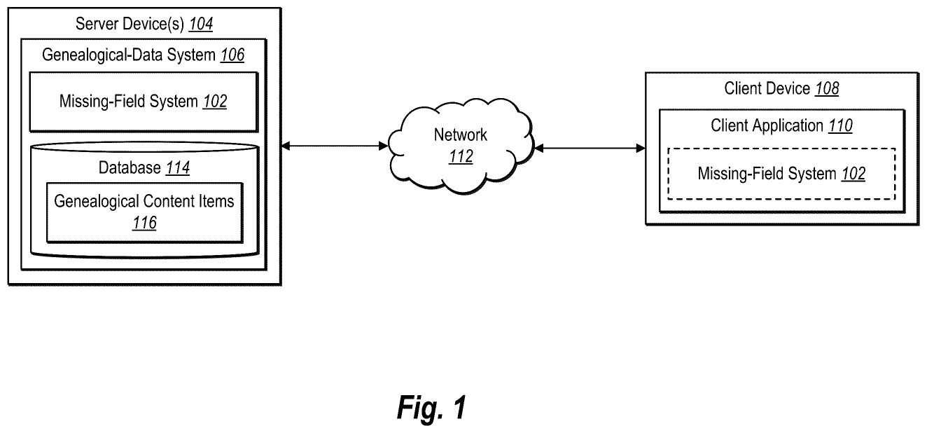

Additional detail regarding the missing-field system will now be provided with reference to the figures. For example, FIG. 1 illustrates a schematic diagram of an example system environment for implementing a missing-field system 102 in accordance with one or more implementations. An overview of the missing-field system 102 is described in relation to FIG. 1. Thereafter, a more detailed description of the components and processes of the missing-field system 102 is provided in relation to the subsequent figures.

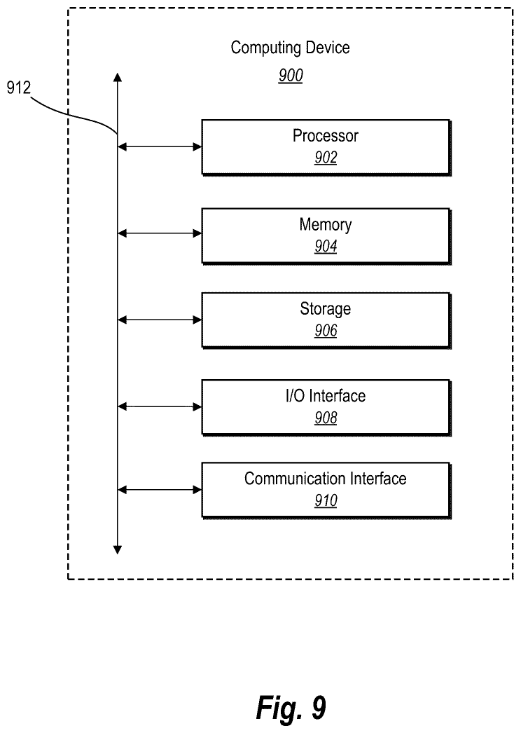

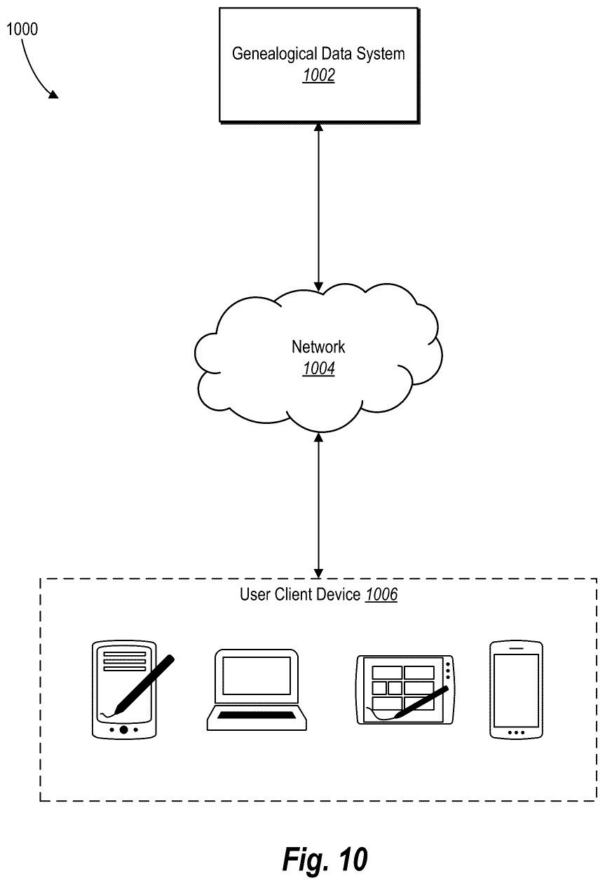

As shown, the environment includes server device(s) 104, a client device 108, a database 114, and a network 112. Each of the components of the environment can communicate via the network 112, and the network 112 may be any suitable network over which computing devices can communicate. Example networks are discussed in more detail below in relation to FIGS. 9-10.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 9-10. The client device 108 can communicate with the server device(s) 104 and/or the database 114 via the network 112. For example, the client device 108 can receive user input from respective users interacting with the client device 108 (e.g., via the client application 110) to, for instance, search for, access, generate, modify, or share a genealogical content item and/or to interact with a genealogy tree or a content item via a graphical user interface of the genealogical-data system 106. In addition, the missing-field system 102 on the server device(s) 104 can receive information relating to various searches for, or interactions with, genealogical content items, and/or user interface elements based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server device(s) 104. Based on instructions from the client application 110, the client device 108 can present or display information, including a user interface such as a genealogical-content-item-search interface, a genealogy-tree interface, a discover interface for additional genealogical content, or some other graphical user interface, as described herein.

As illustrated in FIG. 1, the example environment also includes the server device(s) 104. The server device(s) 104 may generate, track, store, process, receive, and transmit electronic data, such as genealogical content items, search queries, search results, and/or interactions with content items. For example, the server device(s) 104 may receive data from the client device 108 in the form of an indication of a selection to view a particular graphical user interface or to perform a search for a genealogical content item. In addition, the server device(s) 104 can transmit data to the client device 108 in the form of a search result within a graphical user interface. Indeed, the server device(s) 104 can communicate with the client device 108 to send and/or receive data via the network 112. In some implementations, the server device(s) 104 comprise(s) a distributed server where the server device(s) 104 include(s) a number of server devices distributed across the network 112 and located in different physical locations. The server device(s) 104 can comprise one or more content servers, application servers, communication servers, web-hosting servers, machine-learning server, and other types of servers.

As shown in FIG. 1, the server device(s) 104 can also include the missing-field system 102 as part of a genealogical-data system 106. The genealogical-data system 106 can communicate with the client device 108 to perform various functions associated with the client application 110 such as managing user accounts, managing genealogical data, managing genealogy trees, managing genealogical content items, and facilitating user interaction with, and sharing of, the genealogy trees and/or genealogical content items. Indeed, the genealogical-data system 106 can include a network-based cloud storage system to manage, store, and maintain genealogical content items and genealogy trees related data user accounts. For instance, the genealogical-data system 106 can utilize genealogical data across various content items and user accounts to generate and maintain a universal genealogy tree that reflects the relatedness or consanguinity between nodes corresponding to all user accounts and other individuals indicated by stored genealogical content items. In some embodiments, the missing-field system 102 and/or the genealogical-data system 106 utilize the database 114 to store and access information such as genealogical content items, genealogy trees, user account data, and/or other information.

As further illustrated in FIG. 1, the missing-field system 102 includes a database 114 that stores genealogical content items 116. In particular, the missing-field system 102 stores the genealogical content items 116 and searches the genealogical content items 116 to generate search results in response to search queries. For instance, the missing-field system 102 receives a search query from the client device 108 and generates, using a missing field algorithm, a search result that includes one or more records from among the genealogical content items 116.

Although FIG. 1 depicts the missing-field system 102 located on the server device(s) 104, in some implementations, the missing-field system 102 may be implemented by (e.g., located entirely or in part on) one or more other components of the environment. For example, the missing-field system 102 may be implemented in whole or in part by the client device 108. For example, the client device 108 and/or a third-party system can download all or part of the missing-field system 102 for implementation independent of, or together with, the server device(s) 104.

In some implementations, though not illustrated in FIG. 1, the environment may have a different arrangement of components and/or may have a different number or set of components altogether. For example, the client device 108 may communicate directly with the missing-field system 102, bypassing the network 112. As another example, the environment may include multiple client devices, each associated with a different user account. In addition, the environment can include the database 114 located external to the server device(s) 104 (e.g., in communication via the network 112) or located on the server device(s) 104 and/or on the client device 108.

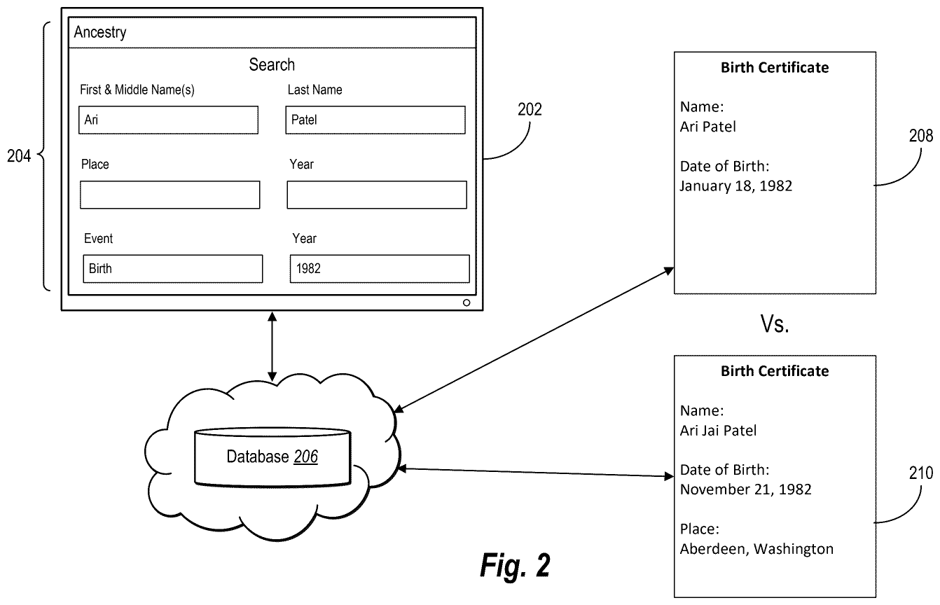

As mentioned above, the missing-field system 102 can surface content items that include new information within data fields missing (or not found) within data fields of a search query. In particular, the missing-field system 102 can utilize a model (e.g., a statistical model or a machine-learning model) to prioritize or rank content items according to data fields defined by a search query (and data fields missing from the search query). FIG. 2 illustrates an example diagram of an overview of the missing-field system 102 identifying and prioritizing content items according to missing data fields in accordance with one or more embodiments. Additional detail regarding the various acts and methods mentioned in FIG. 2 is provided thereafter with reference to subsequent figures.

As illustrated in FIG. 2, the missing-field system 102 generates and provides a search interface 204 for display on a client device 202. In particular, the missing-field system 102 provides the search interface 204 to include interactive elements for defining data fields that outline or make up the parameters of a search query. For instance, the search interface 204 includes fillable elements that define respective data fields. As shown, the search interface 204 includes the following data fields: i) first and middle name, ii) last name, iii) place, iv) year (corresponding to the place), v) event, and vi) year (corresponding to the event). While a certain set of data fields are shown, additional or alternative data fields are possible.

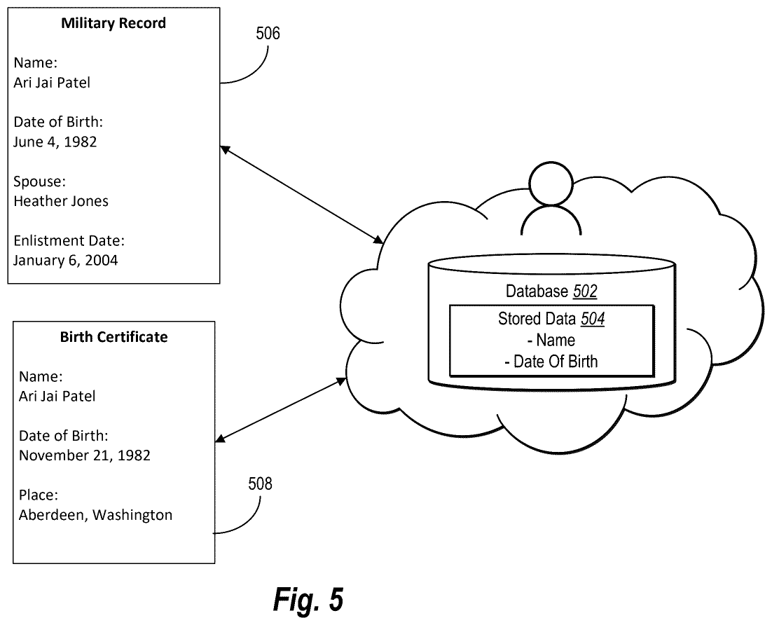

As further illustrated in FIG. 2, the missing-field system 102 receives a search query from the client device 202. Specifically, the missing-field system 102 receives a search query that includes data fields for first and middle name (“Ari”), last name (“Patel”), event (“Birth”), and year of birth (“1982”). Based on receiving the search query defined by the illustrated data fields, the missing-field system 102 searches a database 206 (e.g., the database 114) maintained by the genealogical-data system 106. Indeed, the missing-field system 102 searches the database 206 that stores a repository of genealogical content items to identify those content items that not only match the search query but that also include new information. Additional details regarding the missing-field system 102 searching a repository of genealogical content items to identify content items are provided below with respect to FIG. 5.

For example, the missing-field system 102 utilizes a statistical model, such as a field-weighting model, to generate search results. Specifically, the missing-field system 102 utilizes the field-weighting model to analyze the search query to compare query data fields with content item data fields. For instance, the missing-field system 102 identifies a data field of a content item that exactly matches a data field of a search query and/or identifies a data field that is within a threshold similarity of a query data field. In some cases, the missing-field system 102 determines data field similarity based on character distance (e.g., a distance measure of how similar one string of characters is to another), phonetic similarity, geographic proximity (e.g., between locations, events, and/or individuals), numerical similarity, time/date similarity, and/or other similarity measures. The missing-field system 102 thus utilizes the field-weighting model to identify candidate content items that match (or are within a threshold similarity of) a search query to include within a search result.

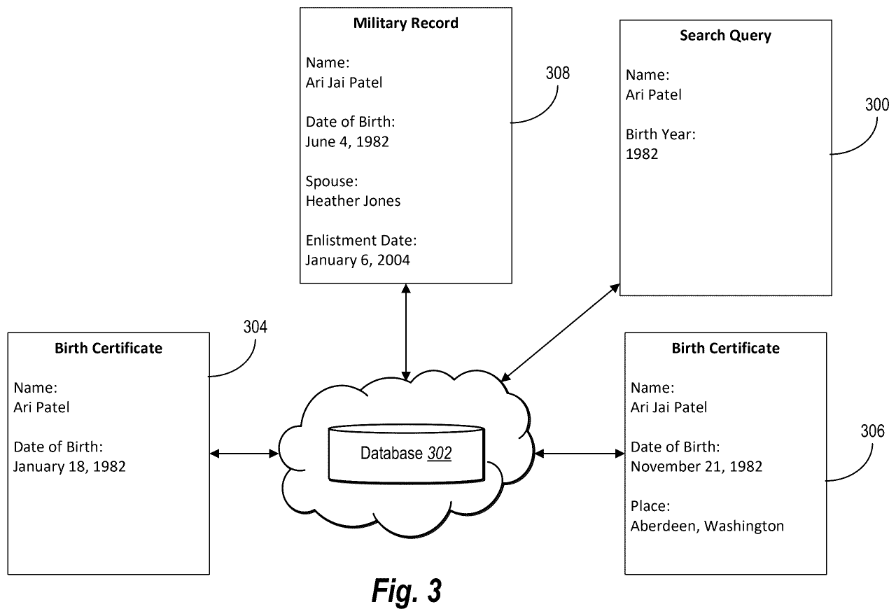

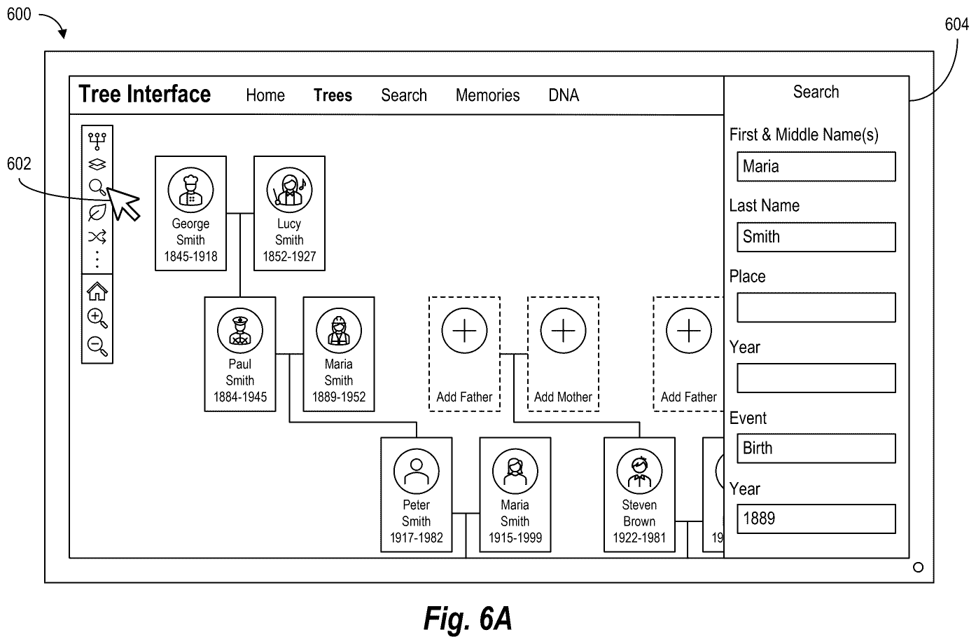

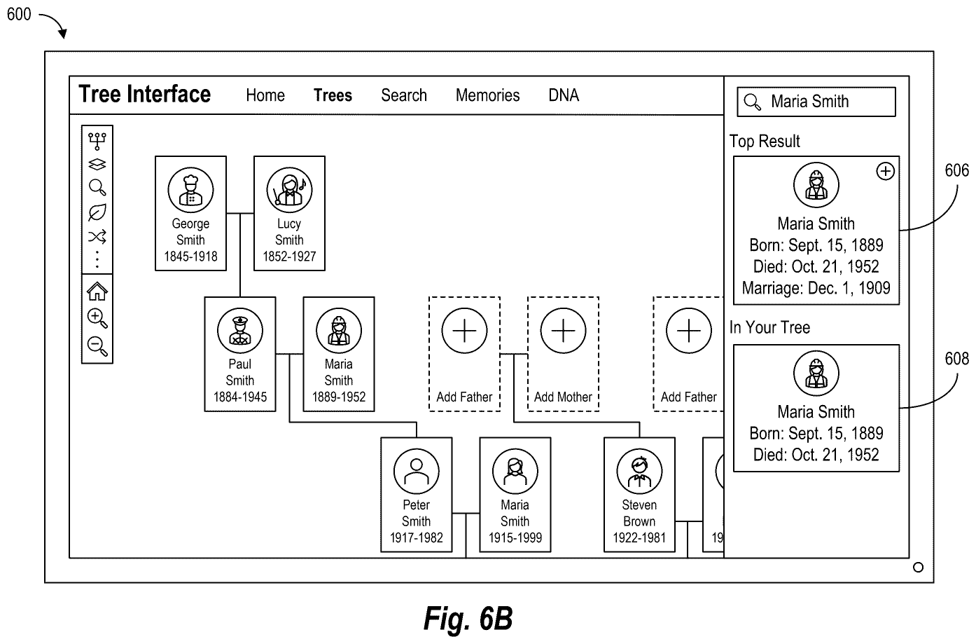

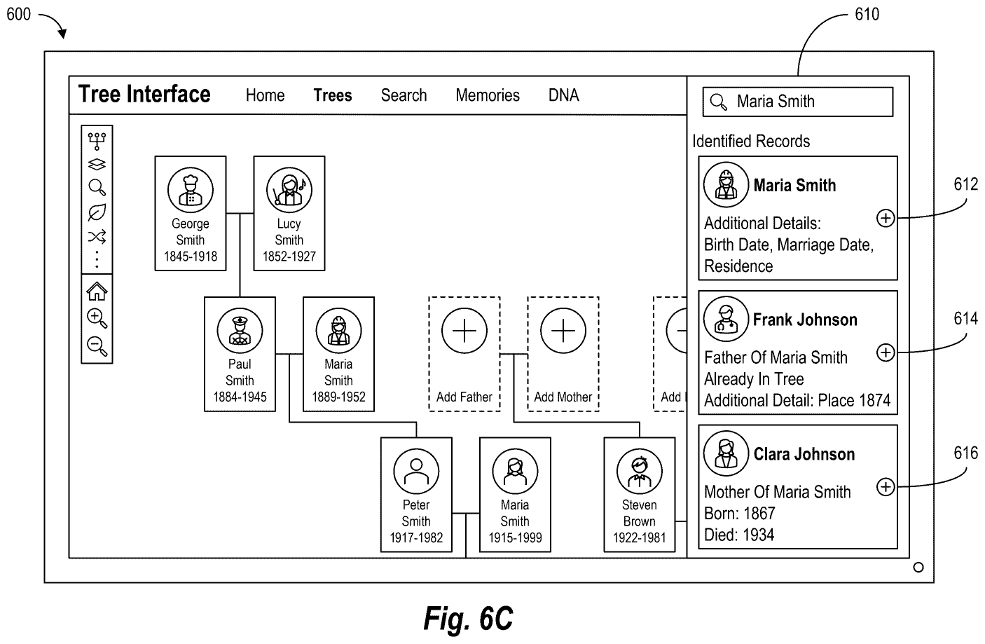

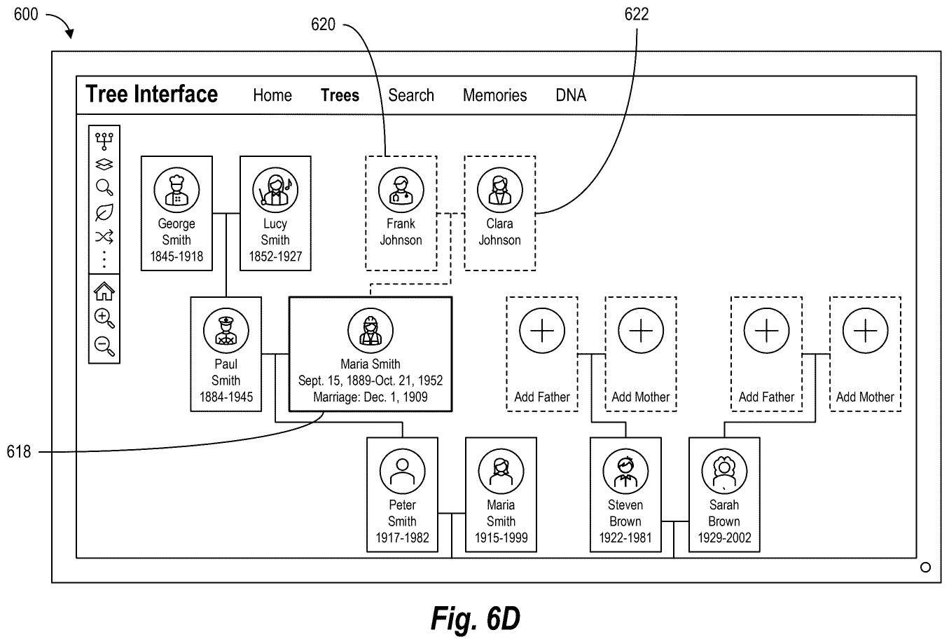

As shown, the missing-field system 102 identifies a content item 208 and a content item 210 as candidate content items. The content item 208 includes a first data field for a name and a second data field for a date of birth. The content item 210 includes a first data field for a name, a second data field for a date of birth, and a third data field for a place (e.g., a place of birth). Both the content item 208 and the content item 210 match or correspond to the search query and are therefore candidate content items. However, as shown, the content item 210 includes an additional data field (“Place”) not found in the search query, while both data fields of the content item 208 are part of the search query. Indeed, example data fields include: i) birth date, ii) birth place, iii) marriage date, iv) marriage place, v) death date, vi) death place, vii) residence date, viii) residence place, ix) spouse name, x) mother's name, xi) father's name, xii) sibling's name, xiii) names of other relatives, xiv) immigration arrival date, xv) emigration departure date, xvi) places and/or dates of other life events for the individual or relatives of the individual. Additional details regarding the missing-field system 102 comparing data fields of content items with data fields of a search query are provided below with respect to FIG. 3. Further, additional details regarding the missing-field system 102 receiving a search query and providing content items are provided below with respect to FIGS. 6A-6D.

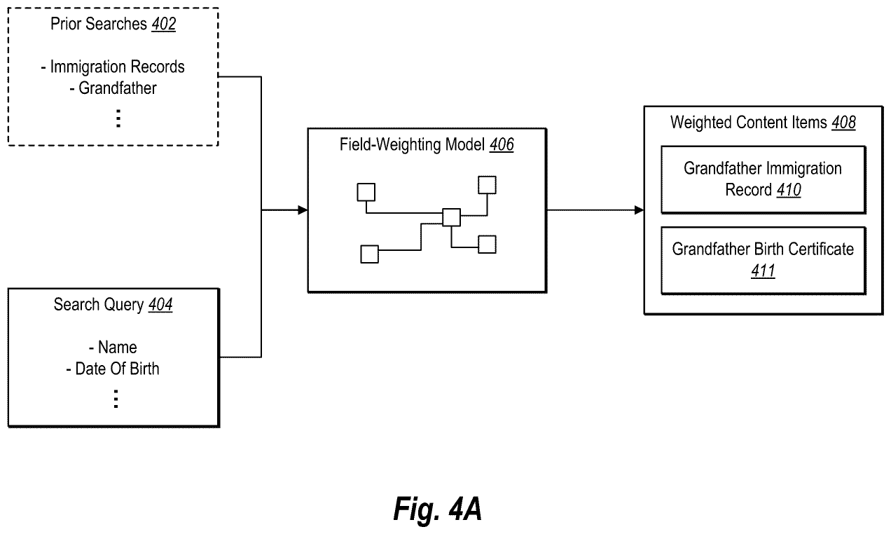

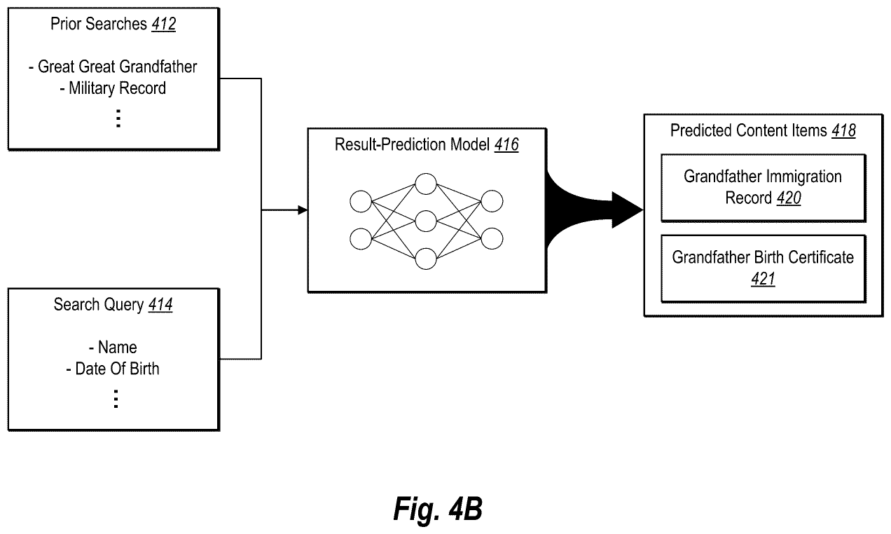

As mentioned, the missing-field system 102 can also utilize the field-weighting model to identify content items that include data fields missing from a search query. For example, the missing-field system 102 utilizes the field-weighting model to apply a weight for each data field found within a candidate content item that is not found in a search query. In some embodiments, the missing-field system 102 applies equal weights to each missing field. In these or other embodiments, the missing-field system 102 applies different weights to different data fields and/or data fields of different content item types/categories. The missing-field system 102 further ranks or prioritizes the content items in a search result according to the missing field weights, where more heavily weighted content items (e.g., those with more missing fields) are ranked above lesser weighted content items. Accordingly, the missing-field system 102 can generate a search result that includes a list of content items for display on the client device 202, where the list is ordered according to the ranking/prioritization (e.g., ranking and listing the content item 210 above the content item 208 because it includes the place field not found in the search query). Additional details regarding the missing-field system 102 utilizing a field-weighting model are provided below with respect to FIG. 4A.

In some embodiments, the missing-field system 102 utilizes a machine-learning model, such as a result-prediction machine-learning model, to generate a search result for a search query. In particular, the missing-field system 102 utilizes a result-prediction machine-learning model to generate a predicted search result in a personalized fashion for the user account submitting the search query. More particularly, the missing-field system 102 determines prior search queries for the user account and utilizes a model (e.g., the result-prediction machine-learning model or another model) to determine or predict a search intent of a current search query based on data fields of the current search query and further based on data fields of prior search queries. For instance, the missing-field system 102 can determine a search intent as a target entity (e.g., individual or organization), a target place, or a target content item sought by a search query. The missing-field system 102 can further encode the search intent and utilize the search intent as input for the result-prediction machine-learning model to generate a search result for the current search query based not only on the data fields but also on the search intent. Additional details regarding the missing-field system 102 utilizing a result-prediction machine-learning model to generate a search result are provided below with respect to FIG. 4B.

While the description of FIG. 2 relates primarily to genealogical content items, in some embodiments, the missing-field system 102 can perform similar functions for other types of content items as well. To elaborate, the missing-field system 102 can utilize a field-weighting model and/or a result-prediction machine-learning model to generate a search result for a search query in a variety of contexts. Indeed, the missing-field system 102 can identify candidate content items that correspond to data fields of a search query and can further prioritize the candidate content items in a search result based on comparing data fields of the content items with data fields of the search query.

Additionally, while FIG. 2 primarily describes identifying content items with preferred missing fields, in some embodiments, the missing-field system 102 can generate a summary of new data found within one or more content items. For example, the missing-field system 102 can determine the data fields within one or more content items that correspond to a query and that include data fields missing from the search query. The missing-field system 102 can further generate a summary of the missing field data (across multiple content items) and can generate links or references to the respective content items from which the missing field data is gathered to include within the summary. The links can be selectable to access the content items including the missing field data. Additional details regarding the missing-field system 102 generating a providing a summary of new data found within one or more content items are provided with respect to FIGS. 6A-6D.

As mentioned above, in certain described embodiments, the missing-field system 102 can compare data fields of content items with data fields of a search query. In particular, the missing-field system 102 compares content items to identify data fields in content items that are missing from a search query and can prioritize content items that include more missing data fields higher than content items that include fewer missing data fields. FIG. 3 illustrates an example diagram for comparing data fields of content items with data fields of a search query in accordance with one or more embodiments.

As illustrated in FIG. 3, the missing-field system 102 receives a search query 300. In particular, the search query 300 defines the data fields for searching a database 302 to identify candidate content items. As shown, the missing-field system 102 identifies content item 304, content item 306, and content item 308 from database 302. In addition, the missing-field system 102 compares the data fields in the content items with the data fields of the search query 300. In particular, the missing-field system 102 compares content items by comparing corresponding data fields between content item 304, content item 306, content item 308, and search query 300. For example, the missing-field system 102 can compare a birth date data field from search query 300 with birth date data fields from content item 304, content item 306, and content item 308.

In one or more embodiments, based on comparing content items, the missing-field system 102 determines or identifies data fields that are missing from the search query 300. As shown, the missing-field system 102 determines that the content item 304 includes no missing data fields, while the content item 306 includes one missing data field, and the content item 308 includes two missing data fields. In certain cases, the missing-field system 102 thus ranks or prioritizes the content items according to numbers of missing data fields (and/or according to which types of data fields are missing and/or the type of content item), ranking the content item 308 first, the content item 306 second, and the content item 304 third. Further, the missing-field system 102 can present the content items in a graphical user interface by display content items according to prioritized order by placing content item 308 first (e.g., top of a list), then content item 306, then content item 304. Examples of the missing-field system 102 displaying content items in prioritized (or ranked) order are provided below with respect to FIGS. 6A-6D.

In addition, the missing-field system 102 can prioritize content items based on determining that a data field of a content item contains additional data than the search query. More particularly, the missing-field system 102 can determine that a data field contains the information from the search query, plus additional details. For example, as shown, search query 300 includes a birth year (1982) and the missing-field system 102 can prioritize content items that include birth date (e.g., month and date or just month) in addition to the birth year.

As shown in FIG. 3, after comparing data fields and identifying additional data not in search query 300, the missing-field system 102 can determine data fields of various content items may conflict. For example, birth date fields of content item 304, content item 306, and content item 308 all include birth year 1982 but the birth dates are different for each respective content item. In these cases, the missing-field system 102 can also determine whether content items correspond to the same individual as in search query 300. Specifically, the missing-field system 102 can compare data fields of content items to determine a likelihood that the content items correspond to the individual of the search query. The missing-field system 102 can prioritize content items that contain information not included in the search query and that are likely to correspond to the search query (e.g., satisfy a threshold likelihood of corresponding to the individual of the query). For instance, the missing-field system 102 can utilize a search intent from previous searches to identify content items (as described below in relation to FIG. 4B) or compare to a genealogical database (as described below in relation to FIG. 5).

As mentioned, the missing-field system 102 identifies whether content items include data fields not included in the search query. In some embodiments, the missing-field system 102 utilizes vectors to identify whether or not a content item has data stored in a data field. Specifically, the missing-field system 102 utilizes a profile field vector that represents the presence, absence, or state of respective data fields within a content item. For example, the missing-field system 102 generates or extracts a profile field vector by generating a bit vector for a content item, where the vector represents data fields with data. For instance, the missing-field system 102 can generate a field vector for a content item, where bit values (e.g., 1s and 0s) of the field vector correspond to data fields and indicate whether or not a data field contains (or stores) data. The missing-field system 102 can then reference a bit value corresponding to a data field to identify whether or not the content item has data includes (or stores) in the data field. In some instances, the missing-field system 102 generates the field vector from values stored within a search platform, such as by accessing doc values within Apache Solr.

In some instances, the missing-field system 102 identifies content items from database 302 that match search query 300, then determines whether or not a content item has a data field not included in the search query based on the field vector for the content item. For example, as shown, the missing-field system 102 can identify that content item 304, content item 306, and content item 308 correspond to search query 300 (e.g., based on determining a similarity between the name data field). The missing-field system 102 then compares a field vector for each of content item 304, content item 306, and content item 308 to identify data fields in each content item that have data not included in search query 300.

The missing-field system 102 can also utilize various degrees of comparison for different data fields. For example, the missing-field system 102 can require that certain data fields require exact matches, such as a birth date data field or a name data field. In other instances, the missing-field system 102 can generate metrics for data fields that indicate a likelihood that the data field of the content item matches a data field in search query 300. For example, the missing-field system 102 can generate a similarity score (e.g., Levenshtein distance or other metric) between data fields. As another example, when comparing place data fields, the missing-field system 102 can generate a geographical proximity check (e.g., to indicate a likelihood that the place data fields of the content items can refer to the same location). Furthermore, as previously mentioned, the missing-field system 102 utilizes a field-weighting model to apply weights to different types of data fields so that some data fields (e.g., name data fields or birth date data fields) have a higher weight than other data fields (e.g., enlistment date data fields). Additional details regarding the missing-field system 102 using a field-weighting model to weight data fields of content items are provided below with respect to FIG. 4A.

In some embodiments, the missing-field system 102 generates a (temporary) query-based genealogy tree for a search query. More specifically, the missing-field system 102 receives a search query for an entity (e.g., and individual) and generates an ephemeral or interim genealogy tree for the searched entity by generating and linking temporary nodes for other entities (e.g., relatives) populated as part of the search results. The missing-field system 102 can further determine the data fields associated with each of the nodes along with what data fields might be missing. The missing-field system 102 can accordingly prioritize content items for the search results according to the missing fields (and weights, search intent, and/or other factors described herein).

As previously noted, in one or more embodiments, the missing-field system 102 utilizes various models to prioritize and/or determine results for a search query. FIGS. 4A-4B illustrate the missing-field system 102 utilizing a field-weighting model and a result-prediction machine-learning model to determine content items for a search query. Specifically, FIG. 4A illustrates an example diagram of utilizing a field-weighting model to identify candidate content items corresponding to a search query and determine weighted content items in accordance with one or more embodiments. FIG. 4B illustrates an example diagram of utilizing a result-prediction machine-learning model to determine a predicted content item for a search result in accordance with one or more embodiments.

As illustrated in FIG. 4A, the missing-field system 102 inputs a search query 404 (including data fields that define the search query 404) into a field-weighting model 406. In turn, the field-weighting model 406 processes the search query 404 to generate weighted content items 408. To elaborate, the field-weighting model 406 generates weighted content items 408 by weighting data fields of content items that correspond to the search query 404 (and/or that align with a search intent indicated by the prior searches 402). For example, the field-weighting model 406 weights each candidate content item according to the number of data fields it includes that are missing from the search query 404.

In some cases, the field-weighting model 406 weights each data field of a content item equally. For example, the field-weighting model can apply a weight (e.g., a weight of equal value) to each data field of the content item, so a weighted content item score for the content item corresponds to data fields for the content item that are not included in search query 404, regardless of a data field type corresponding to the data field. In other cases, the field-weighting model 406 weights different missing data fields differently based on a data field type for the data field that the content item includes but that is not included in search query 404. More particularly, the missing-field system 102 can assign a higher weight to certain data fields, such as place data fields or birth date data fields. As shown, the field-weighting model 406 prioritizes a grandfather immigration record 410 above a grandfather birth certificate 411 based on the weights of missing data fields.

In one or more embodiments, the missing-field system 102 generates weighted content items 408 by weighting content items of a genealogy tree. For instance, the missing-field system 102 can utilize field-weighting model 406 to weight content items stored in a genealogy tree according to data fields included the content items that are not included in search query 404. In some cases, the missing-field system 102 can also prioritize content items from a genealogy tree based on the content items including data fields not included in search query 404 and because the content items are stored in the genealogy tree. For example, if the missing-field system 102 identifies that both a content item stored in a database and a content item stored in a genealogy tree have data fields not included in search query 404, the missing-field system 102 will prioritize the content item from the genealogy tree.

In some instances, the missing-field system 102 generates weighted content items 408 based on distance within a genealogy tree. More particularly, rather than ranking nodes closest to a node associated with a user account for the search query, the missing-field system 102 weights content items with missing fields. For instance, the missing-field system 102 can weight content items that are further away (but within a threshold degree of separation) from a node associated with a user account of the search query but that contain data fields missing from the search query than nodes that are closer to the node of the user account of the search query.

As shown, in one or more embodiments, the missing-field system 102 also input prior searches 402 into the field-weighting model 406. For example, the field-weighting model 406 can utilize prior searches 402 by accessing search data corresponding to prior searches 402 performed by a client device associated with search query 404 and utilize the search data when generating weighted content items 408. For instance, search data of prior searches 402 can include data and corresponding data fields for previous searches and the field-weighting model 406 can adjust weights data fields that correspond to prior searches. As an illustration, if search data of prior searches 402 includes a search for a specified place in a place data field, the field-weighting model 406 can weight place data fields higher when generating weighted content items 408.

In one or more embodiments, prior searches 402 include patterns of previous searches performed by a client device associated with search query 404. Specifically, the missing-field system 102 can determine patterns across prior searches 402 that correspond to a search intent, and the field-weighting model 406 can utilize the search intent to generate weighted content items 408. For instance, the missing-field system 102 can analyze multiple searches to identify patterns that indicate a search intent that the client device is trying to find content items corresponding to a lineage of a genealogical tree. Based on the predicted search intent, the field-weighting model 406 can weight content items that correspond to the lineage of the genealogical tree. As another example, the missing-field system 102 can determine a search intent that a client device is searching for a certain genealogical record and/or content item (e.g., a great-grandfather) and the field-weighting model 406 can adjust weights for data fields and/or records that include fields corresponding to the search intent.

In some cases, the missing-field system 102 can utilize prior searches 402 in combination with a genealogy tree (e.g., a tree for a particular user account performing a search) to generate weighted content items 408. For example, the missing-field system 102 can determine a search intent from prior searches 402 and can further determine which data fields might be missing from a particular genealogy tree. The missing-field system 102 can further utilize the field-weighting model 406 to generate an aggregate weight for data fields in the genealogy tree that also reflect the search intent from prior searches 402 (or that otherwise correspond to previous search queries). Indeed, through weighting content items in the genealogy tree based on prior searches 402, the missing-field system 102 can prioritize content items with data fields not included in search intent and that are in the genealogy tree.

As mentioned above, in certain embodiments, the missing-field system 102 utilizes a result-prediction machine-learning model to generate search results. In particular, the missing-field system 102 utilizes a result-prediction machine-learning model to generate predicted content items corresponding to a search query based on data fields and/or prior search queries. FIG. 4B illustrates an example diagram of utilizing a result-prediction machine-learning model to determine a predicted content item for a search result in accordance with one or more embodiments.

As illustrated in FIG. 4B, the missing-field system 102 utilizes a result-prediction machine-learning model 416 to generate predicted content items 418 as results for search query 414. To elaborate, the missing-field system 102 utilizes the result-prediction machine-learning model 416 to process a search query 414 (and its data fields) and/or prior searches 412 (and their respective data fields). In some cases, the result-prediction machine-learning model 416 generates the predicted content items 418 to reflect a predicted search intent corresponding to the search query 414. For instance, the result-prediction machine-learning model 416 processes the data fields of the search query 414 as well as the data fields of the prior searches 412 to predict a search intent (e.g., a target individual, entity, place, or other information) for the search query 414.

As an example, the result-prediction machine-learning model 416 can predict, based on a pattern of the prior searches 412, that a user account is searching for a name of a great grandfather. To make this determination, the missing-field system 102 determines that the database of the user account already stores the name of the grandfather in the same family line but that the grandfather's birth date is not stored. Thus, based on the search query 414 including data fields defining the name of the grandfather whose data is already stored, and based on prior searches 412 indicating data fields defining the name of the great grandfather, the result-prediction machine-learning model 416 predicts that the search intent is to locate a particular target content item, such as a birth certificate of the grandfather which will likely include the name of the great grandfather.

Accordingly, the result-prediction machine-learning model 416 generates the predicted content items 418 to include a ranked list of content items ordered according to missing data fields and/or search intent. As shown, the result-prediction machine-learning model 416 determines that a grandfather immigration record 420 and a grandfather birth certificate 421 each correspond to the search query 414 and/or the prior searches 412. In addition, the result-prediction machine-learning model 416 ranks the grandfather immigration record 420 above the grandfather birth certificate 421 based on missing fields and/or search intent.

As mentioned, in certain embodiments, the missing-field system 102 compares data fields of content items with data stored in a database. In particular, the missing-field system 102 compares data fields with data stored for a user account with a particular database (of the genealogical-data system 106) as part of prioritizing content items within a search result. FIG. 5 illustrates an example diagram for comparing data fields of content items with stored data in accordance with one or more embodiments.

As illustrated in FIG. 5, the missing-field system 102 identifies a content item 506 and a content item 508 as candidate content items for a search query. In addition, the missing-field system 102 compares the data fields within content item 506 and content item 508 against stored data 504 within a database 502 associated with a particular user account. Specifically, the missing-field system 102 accesses the database 502 associated with a user account (within the genealogical-data system 106) performing a search query to determine the stored data 504 for the user account. The missing-field system 102 can thus compare the stored data 504 with the data fields of content item 506 and content item 508 to determine which data fields are included in the content item 506 and content item 508 that are not among the stored data 504. In some cases, the missing-field system 102 further ranks or prioritizes (for a search query) the content item 506 and content item 508 according to which content items include data fields not included in the stored data 504. As shown, the missing-field system 102 ranks the content item 506 above the content item 508 for including more data fields not in the stored data 504 (e.g., two for the content item 506 and one for the content item 508).

In some embodiments, the missing-field system 102 also compares candidate content items to a genealogy tree for a user account performing the search query to identify data fields in candidate content items that are not in the genealogy tree. More specifically, the missing-field system 102 compares data fields of content item 506 and content item 508 to database 502 to determine which data fields are included in content item 506 and content item 508 that are not included in a genealogical tree. The missing-field system 102 can then prioritize (or rank) content items with data fields that are not in content items of the genealogy tree higher. As an example, if the missing-field system 102 identifies a candidate content item that includes a death date data field while a content item within the genealogy tree does not have a death date data field, the missing-field system 102 will prioritize the content item with the death date data field over the content item in the genealogy tree. Further, as described further below in FIGS. 6A-6D, the missing-field system 102 can update genealogical content items in the genealogy tree with data fields identified in candidate content items not found in genealogical content items.

As previously mentioned, the missing-field system 102 prioritizes and displays content items with missing fields as results for a search query. In particular, the missing-field system 102 identifies results for a search query and prioritizes and displays content items with missing fields within a graphical user interface. FIGS. 6A-6D illustrate example graphical user interfaces of a missing-field system prioritizing and displaying content items with missing fields in accordance with one or more embodiments.

As shown in FIG. 6A, the missing-field system 102 provides a graphical user interface 600 on a client device associated with a user account of the genealogical-data system 106 with a search option 602 for searching for content items. In some cases, as shown, the missing-field system 102 (or the genealogical-data system 106) graphical user interface 600 is a tree interface for displaying genealogy trees and/or content items associated with the user account of the genealogical-data system. Based on a user interaction with search option 602, the missing-field system 102 provides a search interface 604 for receiving a search query. In particular, the missing-field system 102 provides options within search interface 604 for various data fields for a search query. Further, data fields of a search query correspond to structured data fields of databases and/or genealogy trees and the missing-field system 102 compares search components entered in data fields of search interface 604 to the corresponding structured data fields.

As previously mentioned, the missing-field system 102 prioritizes content items that include data fields missing from a search query. As shown in FIG. 6B, the missing-field system 102 identifies content item 606 and content item 608 that correspond to a search query. In particular, the missing-field system 102 prioritizes content item 606 over content item 608 that includes a data field not specified in the search query, a marriage date data field. As shown, the missing-field system 102 can prioritize content item 606 by an indicator (e.g., “top result”) that indicates content item 606 is prioritized over content item 608. In addition, the missing-field system 102 can display prioritized content item by a location within graphical user interface 600, such as by displaying content item 606 above content item 608 or by displaying content item 606 with an indicator (e.g., highlighted or with an indicating mark) denoting content item 606 is prioritized.

As shown in FIG. 6C, in one or more embodiments, as also mentioned, the missing-field system 102 can also generate a summary of data found within content items that does was not part of a search query and/or already stored within a content item. In some cases, as shown, the missing-field system 102 generates a summary 612 that indicates additional details identified for a content item but that are not included in a content item stored for the user account for display within a summary window 610 of graphical user interface 600. For example, summary 612 indicates data fields identified for a content item corresponding to “Maria Smith” that are not included in a stored content item for “Maria Smith” within a database and/or genealogy tree for the user account associated with the search query.

In some embodiments, the missing-field system 102 utilizes a large language model to generate a summary of data. Specifically, the missing-field system 102 utilizes a large language model to identify differences between a search query and a content item and/or between content items. For instance, the missing-field system 102 can utilize a large language model to compare data fields and/or data contained in data fields to detect variations between a content item and a search query and/or between content items. The missing-filed system 102 can also instruct the large language model which changes to include in a summary, such as instructing a large language model to include when a content item contains a data field not in the search query and/or a stored content item in a summary but not when there is a variation in spelling between data fields.

In one or more embodiments, the missing-field system 102 can provide an option within summary 612 to add the additional details to a stored content item associated with the search result.

For instance, as shown, the missing-field system 102 provides an option within summary 612 (“+”) that, when selected adds the additional details to a stored content item. Indeed, by providing an option to add additional data right from summary 612, the missing-field system 102 requires fewer user interface interactions over existing systems that require additional searches and corresponding user interactions to add data to each missing data field.

In addition, as shown, the missing-field system 102 can display summaries of additional data fields and/or content items that are associated with the search query. For instance, the missing-field system 102 can display a summary 614 that includes additional data for a content item associated with a stored content item corresponding to the search query. In some cases, the missing-field system 102 analyzes content items also associated with a data field and the stored content item (e.g., through a field vector). If the missing-field system 102 determines that the additional content items are also missing the data field, the missing-field system 102 can provide a summary of data fields missing from the additional content item, along with an option to add the missing data field to the additional content item.

Moreover, in one or more embodiments, as shown, the missing-field system 102 can also provide content item 616 content items that are not included in a database and/or genealogy tree. Specifically, the missing-field system 102 can also prioritize content items that are not stored in a database and/or genealogy tree for the user account and provide the content item with other prioritized items. For example, the missing-field system 102 can identify that a data field missing from a content item is also stored in a content item that is not stored in the database and/or genealogy tree for the user account and provides an option to add content item 616 to the database and/or genealogy tree.

In addition, as shown in FIG. 6D, the missing-field system 102 can also display a query-based genealogy tree for a search query. Specifically, the missing-field system 102 can provide an indication with a tree interface of graphical user interface 600 that indicates where content items corresponding to a search query are located within a genealogy tree of a user account. For example, the missing-field system 102 can display a content item 618 with an indication that the content item corresponds to the search results (e.g., predicted content items) of the search query.

The missing-field system 102 can also display a query-based genealogy tree by displaying options for content items not in a genealogy tree but that correspond to a search query. Specifically, the missing-field system 102 can prioritize content items that are not in the genealogy tree to display within graphical user interface 600 (e.g., a tree interface). For instance, based on a weighted content item score, the missing-field system 102 displays content item 620 and content item 622 with a corresponding a location in a genealogy tree. Further, the missing-field system 102 can display options to add content item 620 and/or content item 622 from within graphical user interface 600.

The components of the missing-field system 102 can include software, hardware, or both. For example, the components of the missing-field system 102 can include one or more instructions stored on a computer-readable storage medium and executable by processors of one or more computing devices. When executed by one or more processors, the computer-executable instructions of the missing-field system 102 can cause a computing device to perform the methods described herein. Alternatively, the components of the missing-field system 102 can comprise hardware, such as a special purpose processing device to perform a certain function or group of functions. Additionally, or alternatively, the components of the missing-field system 102 can include a combination of computer-executable instructions and hardware.

Furthermore, the components of the missing-field system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the missing-field system 102 may be implemented as part of a stand-alone application on a personal computing device or a mobile device.

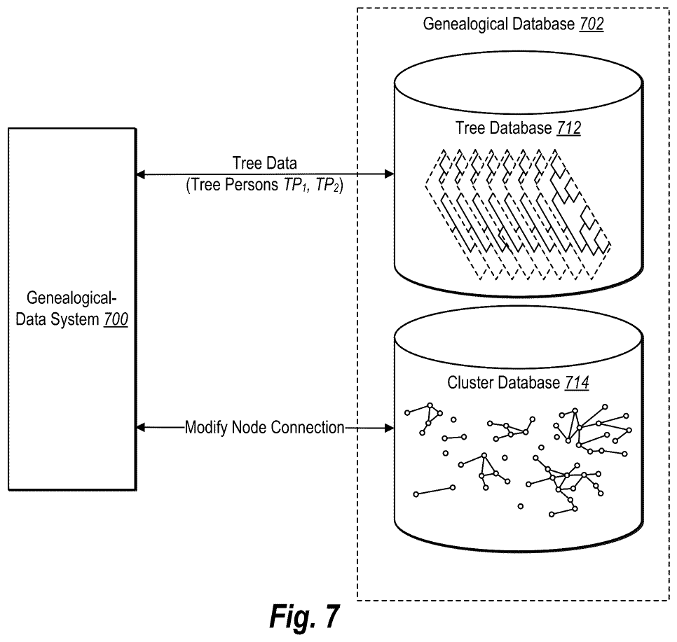

FIG. 7 illustrates a genealogical-data system 700 (e.g., the genealogical-data system 106) interfacing with a genealogical database 702 in accordance with one or more embodiments. For certain genealogical databases, the genealogical-data system 700 identifies groups of user nodes or records in the format of a genealogical tree or records connected by biological and other family relationships as “tree data.” The genealogical-data system 700 can thus search and process tree data stored in a genealogical database 702 (which includes a tree database 712 and a cluster database 714) to execute tasks and perform functions as described herein.

For the genealogical database 702, the genealogical-data system 700 may receive genealogical data (e.g., data records and/or genealogical data objects) for building tree data from a source selected from a ground-truth genealogical tree generated from genealogical records and trees of user accounts within the genealogical-data system 700, from the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, and a motor vehicle database. Additionally, genealogical data can be user-generated. Genealogical data may also include data from a cluster database 714 derived from records and user data.

Some embodiments of the missing-field system 102 relate to modifying a cluster database 714 based on a user query and/or other interaction with the missing-field system 102. In some instances, the genealogical-data system 700 (or the missing-field system 102) determines and/or modifies a node connection for an individual represented by or resolved to a cluster within the cluster database 714. Indeed, the missing-field system 102 can analyze, add, remove, and/or modify genealogical content items organized into clusters within the cluster database 714 based on relatedness corresponding to a common individual. The missing-field system 102 can also access, modify, and analyze genealogical trees within the tree database 712 by, for example, adding nodes, removing nodes, and/or modifying nodes based genealogical content items (and their relationships to individuals) stored within the cluster database 714.

As seen in FIG. 7, the genealogical-data system 700 includes a genealogical database 702, which may include a tree database 712 and a cluster database 714. The tree database 712 may be configured to facilitate the generation, storage, and collation of family trees for a plurality of users, with trees comprising nodes and edges therebetween. Data and records, such as images, may be associated with individual nodes of the trees in the tree database 712. Tree person data, including data such as names, relationships, dates, events, and other metadata may be provided by the tree database 712 to the genealogical-data system 700. The cluster database 714 may include one or more clusters comprising resolved entities, where tree persons (nodes) in different trees in the tree database 712 are associated together in a cluster after determination that the tree persons correspond to a same person.

As a user expands their family tree, e.g. by tagging a previously unknown person in an image using the suggestions provided by the ancestor-identification system and adding the now-identified person to their tree as a new node, the tree database 712 may be modified as the user's family tree is expanded, and the cluster database 714 may be modified to include the new node in the pertinent cluster. Further, the missing-field system 102 can attach a conversation with a user account (e.g., a query received from the user account and a response the missing-field system 102 generates, and/or a series of queries and corresponding responses) to a cluster within the cluster database 714 and/or a node within the tree database 712 to utilize as a ground-truth genealogical tree for future operations within the genealogical-data system 700. For example, the missing-field system 102 can extract or otherwise pull contextual data from the user account or conversations with the user account (e.g., searching databases and/or genealogy trees associated with the user account, prior searches) and attach the context to a node or a cluster of the cluster database 714 to utilize as a ground-truth genealogical tree for future operations within the genealogical-data system 700 and/or the missing-field system 102.

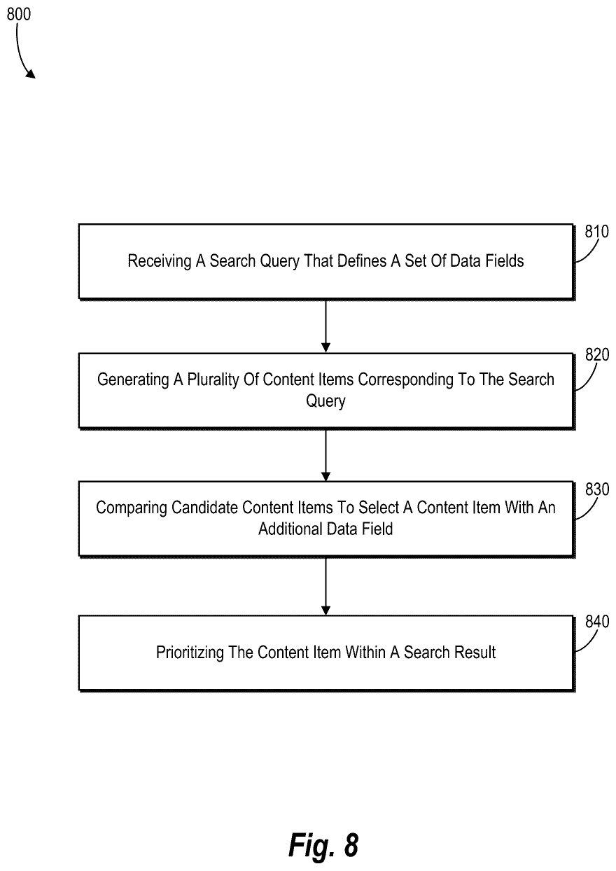

FIGS. 1-7, the corresponding text, and the examples provide a number of different systems and methods for generating and prioritizing search results of content items based on missing data fields. In addition to the foregoing, implementations can also be described in terms of flowcharts comprising acts steps in a method for accomplishing a particular result. For example, FIG. 8 illustrate example series of acts for generating and prioritizing search results of content items based on missing data fields.

While FIG. 8 illustrates acts according to certain implementations, alternative implementations may omit, add to, reorder, and/or modify any of the acts shown in FIG. 8. The acts of FIG. 8 can be performed as part of a method. Alternatively, a non-transitory computer-readable medium can comprise instructions, that when executed by one or more processors, cause a computing device to perform the acts of FIG. 6. In still further implementations, a system can perform the acts of FIG. 8. As illustrated in FIG. 8, the series of acts 800 includes an act 810 of receiving a search query that defines a set of data fields, an act 820 of generating a plurality of content items corresponding to the search query, an act 830 of comparing candidate content items to select a content item with an additional data field, and an act 840 of prioritizing the content item within a search result.

In particular, the act 810 includes receiving, from a client device, a search query that defines a set of data fields for identifying matching content items within a repository of content items, the act 820 includes in response to the search query, generating a plurality of candidate content items corresponding to the set of data fields from the repository of content items, the act 830 includes comparing candidate content items within the plurality of candidate content items to determine a selected content item comprising at least one data field missing from the set of data fields within the search query, and the act 840 includes prioritizing the selected content item within a search result corresponding to the search query for display on the client device.

Further, in one or more embodiments, the series of acts 800 includes analyzing the repository of content items to identify candidate content items with data fields matching the set of data fields indicated by the search query and selecting the plurality of candidate content items from the repository of content items based on identifying that content items of the plurality of candidate content items comprise data fields matching the set of data fields indicated by the search query.

In addition, in one or more embodiments, the series of acts 800 includes generating a plurality of weighted content items from the plurality of candidate content items by utilizing a field-weighting model to weight data fields of the candidate content items, and comparing content items within the plurality of weighted content items to determine the selected content item based on a weight of the at least one data field missing from the set of data fields within the search query.

Moreover, in one or more embodiments, the series of acts 800 includes receiving, from the client device, a prior search query associated with a user account of the client device and generating, utilizing a result-prediction machine-learning model, a predicted search result that includes the selected content item based on the set of data fields within the search query and further based on the prior search query associated with the user account of the client device.

In addition, in one or more embodiments, the series of acts 800 includes generating the plurality of candidate content items by identifying a plurality of stored content items of a user account associated with the client device comprising at least one data field of the set of data fields and comparing stored content items within the plurality of stored content items to determine a stored content item that comprises the at least one data field missing from the set of data fields within the search query.

Additionally, in one or more embodiments, the series of acts 800 includes ranking, within the search result, the selected content item above other content items that include the at least one data field.

Further, in one or more embodiments, the series of acts 800 includes generating the plurality of candidate content items by analyzing the repository of content items to identify candidate content items comprising data fields matching the set of data fields and selecting the plurality of candidate content items based on identifying that content items of the plurality of candidate content items comprise data fields matching the set of data fields indicated in the search query and a data field of a content item of the genealogical tree.

Also, in one or more embodiments, the series of acts 800 includes generate a plurality of weighted content items from the plurality of candidate content items by utilizing a field-weighting model to weight data fields of the candidate content items and comparing weighted content items of the plurality of weighted content items to determine the selected content item based on a weight of the at least one data field missing from the set of data fields within the search query.

Moreover, in one or more embodiments, the series of acts 800 includes comparing the candidate content items of the plurality of candidate content items to content items of the genealogical tree by analyzing data fields of the candidate content items of the plurality of candidate content items to identify a candidate content item comprising at least one data field matching a content item of the genealogical tree, determine that the candidate content item comprises the at least one data field missing from the content item of the genealogical tree and determining the candidate content item as the selected content item based on determining that the candidate content item comprises the at least one data field missing from the content item of the genealogical tree.

Furthermore, in one or more embodiments, the series of acts 800 includes comparing the candidate content items by: generating the plurality of candidate content items by selecting content items stored within a genealogical-data system corresponding to the set of data fields, and comparing content items of the genealogical tree to the plurality of candidate content items from the genealogical-data system.

Also, in one or more embodiments, the series of acts 800 includes receiving, from the client device, a prior search query associated with the genealogical tree, generating, utilizing a result-prediction machine-learning model to generate a predicted search result that includes the selected content item based on the set of data fields within the search query and further based on the prior search query associated with the user account of the client device.

Additionally, the in one or more embodiments, the series of acts 800 includes generating a plurality of weighted content items from the plurality of candidate content items by utilizing a field-weighting model to weight data fields of the repository of candidate content items and comparing content items of the plurality of weighted content items to determine the selected content item based on a weight of the at least one data field missing from the set of data fields within the search query. Furthermore, in one or more embodiments, the series of acts 800 includes prioritizing the selected content item with the search result based on the weight of the at least one data field missing from the set of data fields within the search query.

In addition, in one or more embodiments, the series of acts 800 includes receiving, from a client device, a search query that defines a set of data fields for identifying matching content items stored within a genealogical-data system, in response to the search query, generating a plurality of candidate content items corresponding to the set of data fields from the genealogical-data system, comparing candidate content items within the plurality of candidate content items to determine a selected content item comprising at least one data field missing from the set of data fields within the search query, and prioritize the selected content item within a search result corresponding to the search query for display on the client device.

Moreover, in one or more embodiments, the series of acts 800 includes generating the plurality of candidate content items by analyzing the genealogical-data system to identify candidate content items stored within the genealogical-data system with data fields matching the set of data fields indicated by the search query and selecting the plurality of candidate content items from content items stored within the genealogical-data system based on identifying that content items of the plurality of candidate content items comprise data fields matching the set of data fields indicated by the search query.

Also, in one or more embodiments, the series of acts 800 includes generating a plurality of weighted content items from the plurality of candidate content items by utilizing a field-weighting model to weight data fields of the candidate content items and comparing weighted content items of the plurality of weighted content items to determine the selected content item based on a weight of the at least one data field missing from the set of data fields within the search query.

Moreover, in one or more embodiments, the series of acts 800 includes receiving, from the client device, a prior search query associated with a user account of the client device, generating, utilizing a result-prediction machine-learning model, a predicted search result that includes the selected content item based on the set of data fields within the search query and further based on the prior search query associated with the user account of the client device.

Further, in one or more embodiments, the series of acts 800 includes prioritizing the selected content item by ranking, within the search result, the selected content item above other content items of the genealogical-data system that include the at least one data field.

In addition, in one or more embodiments, the series of acts 800 includes generating the plurality of candidate content items by selecting, from content items stored within the genealogical-data system, content items corresponding to the set of data fields and comparing content items within the plurality of candidate content items to determine the selected content item comprising the at least one data field missing from the set of data fields within the search query

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-Attorney executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of exemplary computing device 900 (e.g., the server device(s) 104 and/or the client device 108) that may be configured to perform one or more of the processes described above. One will appreciate that server device(s) 104 and/or the client device 108 may comprise one or more computing devices such as computing device 900. As shown by FIG. 8, computing device 900 can comprise processor 902, memory 904, storage device 906, I/O interface 908, and communication interface 910, which may be communicatively coupled by way of communication infrastructure 912. While an exemplary computing device 900 is shown in FIG. 8, the components illustrated in FIG. 8 are not intended to be limiting. Additional or alternative components may be used in other implementations. Furthermore, in certain implementations, computing device 900 can include fewer components than those shown in FIG. 8. Components of computing device 900 shown in FIG. 8 will now be described in additional detail.

In particular implementations, processor 902 includes hardware for executing instructions, such as those making up a computer program. As an example, and not by way of limitation, to execute instructions, processor 902 may retrieve (or fetch) the instructions from an internal register, an internal cache, memory 904, or storage device 906 and decode and execute them. In particular implementations, processor 902 may include one or more internal caches for data, instructions, or addresses. As an example, and not by way of limitation, processor 902 may include one or more instruction caches, one or more data caches, and one or more translation lookaside buffers (TLBs). Instructions in the instruction caches may be copies of instructions in memory 904 or storage device 906.

Memory 904 may be used for storing data, metadata, and programs for execution by the processor(s). Memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 904 may be internal or distributed memory.

Storage device 906 includes storage for storing data or instructions. As an example and not by way of limitation, storage device 906 can comprise a non-transitory storage medium described above. Storage device 906 may include a hard disk drive (HDD), a floppy disk drive, flash memory, an optical disc, a magneto-optical disc, magnetic tape, or a Universal Serial Bus (USB) drive or a combination of two or more of these. Storage device 906 may include removable or non-removable (or fixed) media, where appropriate. Storage device 906 may be internal or external to computing device 900. In particular implementations, storage device 906 is non-volatile, solid-state memory. In other implementations, Storage device 906 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 908 allows a user to provide input to, receive output from, and otherwise transfer data to and receive data from computing device 900. I/O interface 908 may include a mouse, a keypad or a keyboard, a touch screen, a camera, an optical scanner, network interface, modem, other known I/O devices or a combination of such I/O interfaces. I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 908 is configured to provide graphical data to a display for presentation to a user. The graphical data may be representative of one or more graphical user interfaces and/or any other graphical content as may serve a particular implementation.

Communication interface 910 can include hardware, software, or both. In any event, communication interface 910 can provide one or more interfaces for communication (such as, for example, packet-based communication) between computing device 900 and one or more other computing devices or networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 910 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 910 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 912 may include hardware, software, or both that couples components of computing device 900 to each other. As an example and not by way of limitation, communication infrastructure 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 10 is a schematic diagram illustrating environment 1000 within which one or more implementations of the missing-field system 102 can be implemented. For example, the missing-field system 102 may be part of a genealogical-data system 1002 (e.g., the genealogical-data system 106). The genealogical-data system 1002 may generate, store, manage, receive, and send digital content (such as genealogical content items). For example, genealogical-data system 1002 may send and receive digital content to and from user client devices 1006 by way of network 1004. In particular, genealogical-data system 1002 can store and manage genealogical databases for various user accounts, historical records, and genealogy trees. In some embodiments, the genealogical-data system 1002 can manage the distribution and sharing of digital content between computing devices associated with user accounts. For instance, the genealogical-data system 1002 can facilitate a user account sharing a genealogical content item with another user account of genealogical-data system 1002.

In particular, the genealogical-data system 1002 can manage synchronizing digital content across multiple user client devices 1006 associated with one or more user accounts. For example, a user may edit a digitized historical document or a node within a genealogy tree using user client device 1006. The genealogical-data system 1002 can cause user client device 1006 to send the edited genealogical content to the genealogical-data system 1002, whereupon the genealogical-data system 1002 synchronizes the genealogical content on one or more additional computing devices.

As shown, the user client device 1006 may be a desktop computer, a laptop computer, a tablet computer, an augmented reality device, a virtual reality device, a personal digital assistant (PDA), an in-or out-of-car navigation system, a handheld device, a smart phone or other cellular or mobile phone, or a mobile gaming device, other mobile device, or other suitable computing devices. The user client device 1006 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1004.

The network 1004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which user client devices 1006 may access genealogical-data system 1002.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from a client device, a search query that defines a set of data fields for identifying matching content items within a repository of content items;
in response to the search query, generating a plurality of candidate content items corresponding to the set of data fields from the repository of content items;
comparing candidate content items within the plurality of candidate content items to determine a selected content item comprising at least one data field missing from the set of data fields within the search query; and
prioritizing the selected content item within a search result corresponding to the search query for display on the client device.

2. The computer-implemented method of claim 1, wherein generating the plurality of candidate content items further comprises:
analyzing the repository of content items to identify candidate content items with data fields matching the set of data fields indicated by the search query; and
selecting the plurality of candidate content items from the repository of content items based on identifying that content items of the plurality of candidate content items comprise data fields matching the set of data fields indicated by the search query.

3. The computer-implemented method of claim 1, wherein comparing the candidate content items further comprises:
generating a plurality of weighted content items from the plurality of candidate content items by utilizing a field-weighting model to weight data fields of the candidate content items; and
comparing content items within the plurality of weighted content items to determine the selected content item based on a weight of the at least one data field missing from the set of data fields within the search query.

4. The computer-implemented method of claim 1, items further comprising:
receiving, from the client device, a prior search query associated with a user account of the client device; and
generating, utilizing a result-prediction machine-learning model, a predicted search result that includes the selected content item based on the set of data fields within the search query and further based on the prior search query associated with the user account of the client device.

5. The computer-implemented method of claim 1, wherein comparing the candidate content items further comprises:
generating the plurality of candidate content items by identifying a plurality of stored content items of a user account associated with the client device comprising at least one data field of the set of data fields; and
comparing stored content items within the plurality of stored content items to determine a stored content item that comprises the at least one data field missing from the set of data fields within the search query.

6. The computer-implemented method of claim 1. wherein prioritizing the selected content item comprises ranking. within the search result, the selected content item above other content items that include the at least one data field.

7. A non-transitory computer readable medium storing instructions which, when executed by at least one processor, cause the at least one processor to:
receive, from a client device, a search query associated with a genealogical tree of a user account of the client device and that defines a set of data fields for identifying matching content items within a repository of content items;
in response to the search query, generate a plurality of candidate content items corresponding to the set of data fields from the repository of content items;
compare candidate content items of the plurality of candidate content items to content items of the genealogical tree to determine a selected content item from the plurality of candidate content items comprising at least one data field missing from the content items of the genealogical tree; and
prioritize the selected content item within a search result corresponding to the search query for display on the client device.

8. The non-transitory computer readable medium of claim 7, further storing instructions which, when executed by at least one processor, cause the at least one processor to generate the plurality of candidate content items by:
analyzing the repository of content items to identify candidate content items comprising data fields matching the set of data fields; and
selecting the plurality of candidate content items based on identifying that content items of the plurality of candidate content items comprise data fields matching the set of data fields indicated in the search query and a data field of a content item of the genealogical tree.

9. The non-transitory computer readable medium of claim 7, further storing instructions which, when executed by at least one processor, cause the at least one processor to:
generate a plurality of weighted content items from the plurality of candidate content items by utilizing a field-weighting model to weight data fields of the candidate content items; and
compare weighted content items of the plurality of weighted content items to determine the selected content item based on a weight of the at least one data field missing from the set of data fields within the search query.

10. The non-transitory computer readable medium of claim 7, further storing instructions which, when executed by at least one processor, cause the at least one processor to compare the candidate content items of the plurality of candidate content items to content items of the genealogical tree by:
analyzing data fields of the candidate content items of the plurality of candidate content items to identify a candidate content item comprising at least one data field matching a content item of the genealogical tree;
determine that the candidate content item comprises the at least one data field missing from the content item of the genealogical tree; and
determine the candidate content item as the selected content item based on determining that the candidate content item comprises the at least one data field missing from the content item of the genealogical tree.

11. The non-transitory computer readable medium of claim 7, further storing instructions which, when executed by at least one processor, cause the at least one processor to compare the candidate content items by:
generating the plurality of candidate content items by selecting content items stored within a genealogical-data system corresponding to the set of data fields; and
comparing content items of the genealogical tree to the plurality of candidate content items from the genealogical-data system.

12. The non-transitory computer readable medium of claim 7, further storing instructions which, when executed by at least one processor, cause the at least one processor to:
receive, from the client device, a prior search query associated with the genealogical tree;
generate, utilizing a result-prediction machine-learning model to generate a predicted search result that includes the selected content item based on the set of data fields within the search query and further based on the prior search query associated with the user account of the client device.

13. The non-transitory computer readable medium of claim 7, further storing instructions which, when executed by at least one processor, cause the at least one processor to:
generate a plurality of weighted content items from the plurality of candidate content items by utilizing a field-weighting model to weight data fields of the repository of candidate content items; and
comparing content items of the plurality of weighted content items to determine the selected content item based on a weight of the at least one data field missing from the set of data fields within the search query.

14. The non-transitory computer readable medium of claim 13, further storing instructions which, when executed by at least one processor, cause the at least one processor to prioritize the selected content item with the search result based on the weight of the at least one data field missing from the set of data fields within the search query.

15. A system comprising:
one or more memory devices; and
one or more processors coupled to the one or more memory devices, wherein the one or more processors are configured to cause the system to:
receive, from a client device, a search query that defines a set of data fields for identifying matching content items stored within a genealogical-data system;
in response to the search query, generate a plurality of candidate content items corresponding to the set of data fields from the genealogical-data system;
compare candidate content items within the plurality of candidate content items to determine a selected content item comprising at least one data field missing from the set of data fields within the search query; and
prioritize the selected content item within a search result corresponding to the search query for display on the client device.

16. The system of claim 15, wherein the one or more processors are further configured to cause the system to generate the plurality of candidate content items by:
analyzing the genealogical-data system to identify candidate content items stored within the genealogical-data system with data fields matching the set of data fields indicated by the search query; and
selecting the plurality of candidate content items from content items stored within the genealogical-data system based on identifying that content items of the plurality of candidate content items comprise data fields matching the set of data fields indicated by the search query.

17. The system of claim 15, wherein the one or more processors are further configured to cause the system to:
generate a plurality of weighted content items from the plurality of candidate content items by utilizing a field-weighting model to weight data fields of the candidate content items; and
compare weighted content items of the plurality of weighted content items to determine the selected content item based on a weight of the at least one data field missing from the set of data fields within the search query.

18. The system of claim 15, wherein the one or more processors are further configured to cause the system to:
receive, from the client device, a prior search query associated with a user account of the client device;
generate, utilizing a result-prediction machine-learning model, a predicted search result that includes the selected content item based on the set of data fields within the search query and further based on the prior search query associated with the user account of the client device.

19. The system of claim 15, wherein the one or more processors are further configured to cause the system to prioritize the selected content item by ranking, within the search result, the selected content item above other content items of the genealogical-data system that include the at least one data field.

20. The system of claim 15, wherein the one or more processors are further configured to cause the system to generate the plurality of candidate content items by:
generating the plurality of candidate content items by selecting, from content items stored within the genealogical-data system, content items corresponding to the set of data fields; and
comparing content items within the plurality of candidate content items to determine the selected content item comprising the at least one data field missing from the set of data fields within the search query.
